(19) United States
(12) Patent Application Publication
(10) Pub. No.: US 2018/0375563 A1
(43) Pub. Date: Dec. 27, 2018

(54) METHODS AND DEVICES FOR SIGNAL PROCESSING IN COMMUNICATION SYSTEM

(71) Applicant: ALCATEL LUCENT, Nozay (FR)

(72) Inventor: Huan Sun, Shanghai (CN)

(73) Assignee: Alcatel Lucent, Nozay (FR)

(21) Appl. No.: 16/063,413

(22) PCT Filed: Nov. 17, 2016
(86) PCT No.: PCT/IB2016/001862

§ 371 Date: Jun. 18, 2018

(30) Foreign Application Priority Data
Dec. 18, 2015 (CN) 201510960780.9

(51) Int. Cl. H04B 7/06; H04L 5/00; H04W 24/10; H04W 36/08

(52) U.S. Cl. CPC H04B 7/0689; H04L 5/0051; H04W 36/08; H04B 7/0617; H04W 24/10

(57) ABSTRACT

The present disclosure relates to methods and devices for signal processing in a communication system. Embodiments of the present disclosure provide a method of signal transmission implemented in a base station, comprising: transmitting a narrow band signal on a part of a system bandwidth used by the base station; and while the narrow band signal is transmitted, setting at least a part of available bandwidth from the system bandwidth used by the base station unused for signal transmission. Embodiments of the present disclosure further provide a signal processing method implemented in a UE, comprising: receiving a narrow band signal transmitted on a part of a system bandwidth used by a base station, wherein, while the narrow band signal is transmitted by the base station, at least a part of an available bandwidth from a system bandwidth used by the base station is set unused for signal transmission. Embodiments of the present disclosure also disclose an apparatus of signal transmission in a base station and an apparatus of signal processing in a UE.

### FIELD

Embodiments of the present disclosure relate to methods and devices for signal transmission and processing in a communication network, and specifically relate to methods and devices for signal transmission and processing in 5G millimeter wave networks.

### BACKGROUND

Millimeter wave communication (MMC) has been regarded as one of the key technologies in the future 5G wireless network, which is expected to support over ten Gigabits level data transmission. However, there is a big challenge in the channel quality of millimeter wave communication due to the server propagation loss. Fortunately, compact antenna can be well utilized in MMC networks due to the shorter wave length than the counterpart in 4G networks.

Beam-based transmitting solutions can significantly improve the channel quality and support high data rate transmission. This indicates that 5G high frequency band system will be a beam-based system, which is the key difference with the conventional 4G system. Although with many notable advantages, the beam-based solutions have to face some potential challenges. One of key challenges is how to implement the measurements and reports to enable mobility management for mobile users.

In prior art, for supporting the mobility management in LTE/LTE-A networks, a terminal station measures the downlink channel quality of a serving cell and neighboring cells, and then feeds back the measurement reports according to the related configurations. Those measurements are implemented by measuring the Reference Signal Received Power (RSRP) or Reference Signal Received Quality (RSPQ). Those reference signals (RS) spread in the whole bandwidth. Furthermore, those RSs are non-pre-coded in the transmission in order to guarantee that all candidate users can fulfil the RSRP or RSRQ measurements and send the related reports in time. This measurement mechanism works efficiently in LTE/LTE-A networks.

However, in 5G MMW networks, non-pre-coded RS may not be received by the terminal station due to the severe propagation loss. This means that the existing measurement mechanism cannot be directly extended to the future 5G networks to support user mobility management.

### SUMMARY

In embodiments of the present disclosure, a new mechanism is provided for downlink signal transmission and signal processing to efficiently support mobility management in beam-based 5G networks with high frequency band.

According to one aspect of the present disclosure, there is provided a method of signal processing implemented in a base station, comprising: transmitting a narrow band signal on a part of a system bandwidth used by the base station; and while the narrow band signal is transmitted, setting at least a part of an available bandwidth from the system bandwidth used by the base station unused for signal transmission.

In the method according to embodiments of the present disclosure, the transmitting a narrow band signal on a part of a system bandwidth used by the base station comprises: transmitting the non-beam formed narrow band signal on at least one antenna port.

The method according to embodiments of the present disclosure further comprises: increasing a transmission power for the narrow band signal.

In the method according to embodiments of the present disclosure, the transmitting a narrow band signal on a part of a system bandwidth used by the base station comprises: if the number of antenna ports is greater than 1, using a transmission diversity mode to transmit the narrow band signal on the part of the system bandwidth used by the base station.

In the method according to embodiments of the present disclosure, the narrow band signal includes a reference signal.

In the method according to embodiments of the present disclosure, the reference signal is used to differentiate different base stations of a plurality of base stations.

In the method according to embodiments of the present disclosure, the narrow band signal is located in a center of the system bandwidth used by the base station.

In the method according to embodiments of the present disclosure comprises, after the transmission of the narrow band signal, transmitting, based on a feedback on the narrow band signal, a wideband signal on at least one antenna port different from an antenna port used for transmitting the narrow band signal.

In the method according to embodiments of the present disclosure, transmitting the wideband signal on at least one antenna port different from an antenna port used for transmitting the narrow band signal comprises: transmitting the wideband signal based on a request from at least one UE (user equipment).

In the method according to embodiments of the present disclosure, transmitting the wideband signal on at least one antenna port different from an antenna port used for transmitting the narrow band signal comprises: transmitting a beam-formed wideband signal on the at least one antenna port different from the antenna port used for transmitting the narrow band signal.

In the signal transmission method according to embodiments of the present disclosure, the wideband signal includes a reference signal.

In the signal transmission method according to embodiments of the present disclosure, the reference signal is used to differentiate different base stations of a plurality of base stations.

According to another aspect of the present disclose, there is provided a method of signal processing implemented in a UE, comprising: receiving a narrow band signal transmitted on a part of a system bandwidth used by a base station, wherein, while the narrow band signal is transmitted by the base station, at least a part of an available bandwidth from the system bandwidth used by the base station is set unused for signal transmission.

The method according to embodiments of the present disclosure further comprises: transmitting a feedback on the narrow band signal to the base station.

The method according to embodiments of the present disclosure further comprises: receiving a wideband signal transmitted on at least one antenna port different from an antenna port used for transmitting the narrow band signal.

The method according to embodiments of the present disclosure further comprises: receiving a beam-formed wideband signal on at least one antenna port different from the antenna port used for transmitting the narrow band signal.

The method according to embodiments of the present disclosure further comprises: transmitting a feedback on the wideband signal to the base station.

The method according to embodiments of the present disclosure further comprises: transmitting, to the base station, a wideband signal for an uplink channel information measurement by the base station; or transmitting, to the base station, a request for initiating a wideband signal transmission to a further UE.

According to a further aspect of the present disclosure, there is provided an apparatus in a base station, comprising: a first transmission unit configured to transmit a narrow band signal on a part of a system bandwidth used by the base station; and a setting unit configured to, while the narrow band signal is transmitted by the base station, set at least a part of an available bandwidth from the system bandwidth used by the base station unused for signal transmission.

According to another further aspect of the present disclosure, there is provided an apparatus of signal transmission in a UE, comprising: a first receiving unit configured to receive, from a base station, a narrow band signal transmitted on a part of a system bandwidth used by the base station, wherein, while the narrow band signal is transmitted by the base station, at least a part of an available bandwidth from the system bandwidth used by the base station is set unused for signal transmission.

Embodiments of the present disclosure at least have the following advantages. By ensuring finding the potential users requiring handover as soon as possible, the shortages of beam scanning can be avoided, thereby achieving low latency. Moreover, based on the reports from the operations on narrow band signals, beam-based wideband measurements may be required for particular users, and those measurements reflect the effective downlink channel quality of the serving cell and neighboring cells, respectively, which improves performance of the handover procedure. In this way, high efficiency is achieved.

### BRIEF DESCRIPTION OF THE DRAWINGS

In the present disclosure, with reference to the accompanying drawings, embodiments as proposed in the present disclosure will be described in detail hereinafter.

Dashed boxes or dotted arrows in the drawings represent optional steps or optional operations. In the drawings:

FIG. 1 illustrates typical downlink transmission according to embodiments of the present disclosure;

FIG. 2 illustrates an antenna array involved in embodiments of the present disclosure;

FIG. 3 illustrates a narrow band RS according to embodiments of the present disclosure;

FIG. 4 illustrates transmission of a narrow band RS according to embodiments of the present disclosure;

FIG. 5 illustrates a wideband RS according to embodiments of the present disclosure;

FIG. 6 illustrates a handover procedure within an eNB according to one embodiment of the present disclosure;

FIG. 7 illustrates a handover procedure between eNBs through an X2 interface according to another embodiment of the present disclosure;

FIG. 8 illustrates a handover procedure between eNBs through an S1 interface according to a further embodiment of the present disclosure;

FIG. 9 illustrates a flowchart of a signal transmission method in a base station according to various embodiments of the present disclosure;

FIG. 10 illustrates a flowchart of a signal processing method in a UE according to various embodiments of the present disclosure;

FIG. 11 illustrates a block diagram of a signal transmitting device in a base station according to embodiments of the present disclosure; and

FIG. 12 illustrates a block diagram of a signal processing device in a UE according to embodiments of the present disclosure.

### DETAILED DESCRIPTION OF EMBODIMENTS

In this section, examples will be presented in detail to show principles of the solution as proposed in the present disclosure.

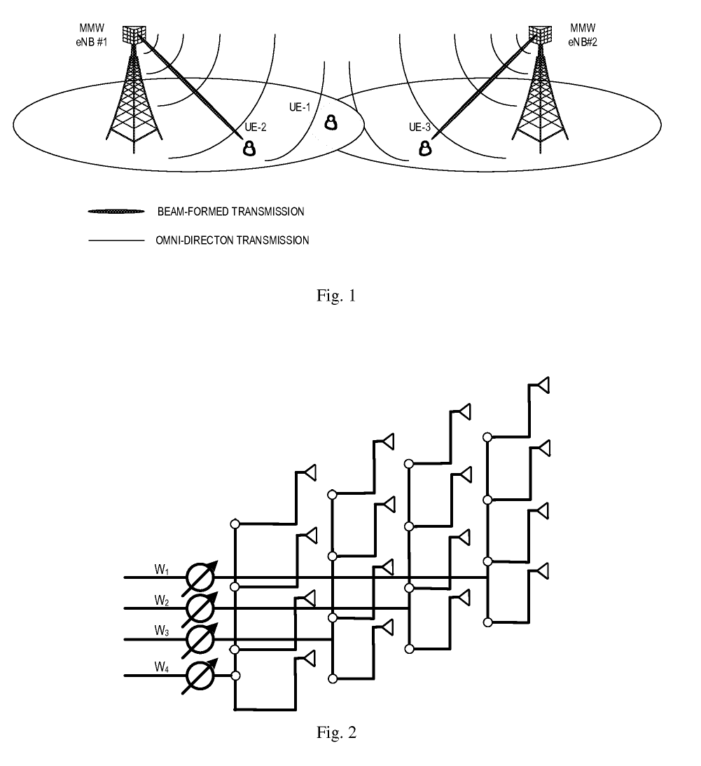

FIG. 1 illustrates a typical downlink transmission scenario according to embodiments of the present disclosure where two MMW cells eNB #1 and eNB#2, as well as three users UE-1, UE-2 and UE-3, are illustrated.

For 5G MMW, a large scale antenna array may be integrated in the system. FIG. 2 illustrates an example of the antenna array, and explains the proposed solution in the following section using the example of the antenna array. It will be appreciated that the proposed solution may actually be used in any large scale antenna array structure.

According to the present disclosure, special narrow band RS can be designed in 5G MMW networks and used for assisting users in performing cell searching, random access and rough transceiver beam-alignment. Further, the RS may be mapped to any transmit antenna elements, while other remaining antenna elements may be used for beam-based data transmission.

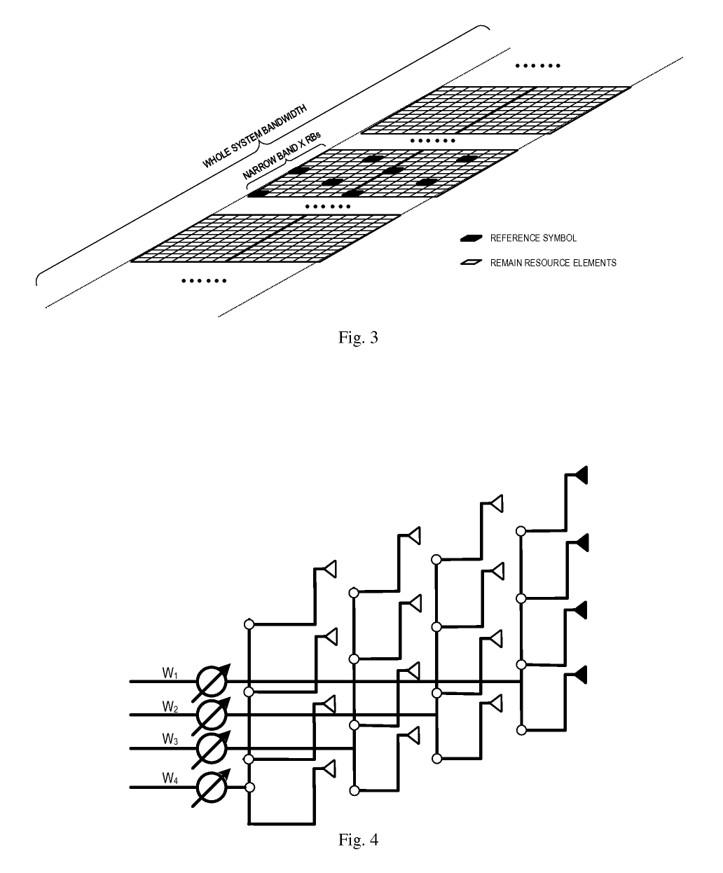

According to the present disclosure, different data being transmitted includes RS. For example, FIG. 3 illustrates a narrow band RS according to embodiments of the present disclosure. Meanwhile, FIG. 5 illustrates a beam-formed wideband RS, which employs a similar RS structure as used in the LTE-A.

According to the present disclosure, different user transmission modes may be employed during different data transmissions. For example, FIG. 4 illustrates an example of transmission of a narrow band RS according to embodiments of the present disclosure. In FIG. 4, an antenna port 1 (comprising four antenna elements marked black) is configured to transmit the narrow band signal with a dedicated RS. The used transmission mode (TM) is configured to be “Transmit Diversity” to guarantee that all candidate users can receive those signals. The TM used herein is the same as in the 4G networks. The other remaining antenna ports may be configured to transmit data to the scheduled users via beam-formed transmission.

To support the mobility management in the beam-based 5G MMW networks, the procedure proposed according to embodiments of the present disclosure may be divided into three phases.

In the first phase, eNB transmits a narrow band and non-beam-formed RS. Taking narrow band power boosting, it guarantees all candidate users can measure the required downlink channel quality information and feed the related reports back. The reports include the serving cell information and the neighboring cells' information.

In the second phase, based on the results achieved in the first phase, eNB transmits a beam-formed wideband RS. The specified user measures wideband channel quality information, and feeds back the measurement report including the serving cell information and neighboring cells' information.

In the third phase, eNB implements mobility management according to the measurement reports obtained from the second phase.

The detailed processes of mobility management in different application scenarios are described as below.

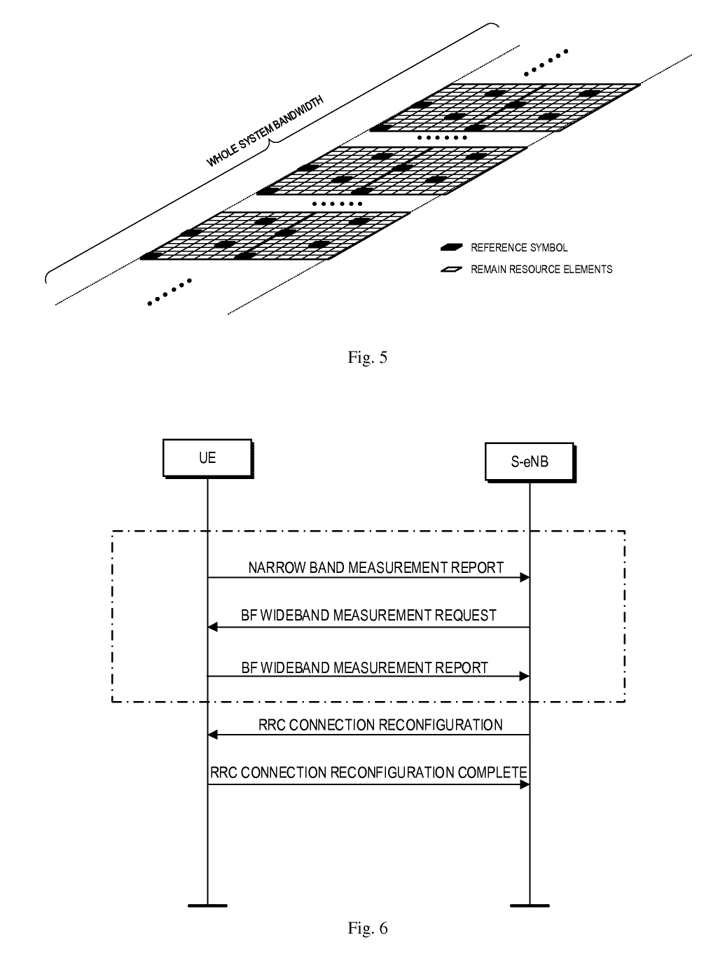

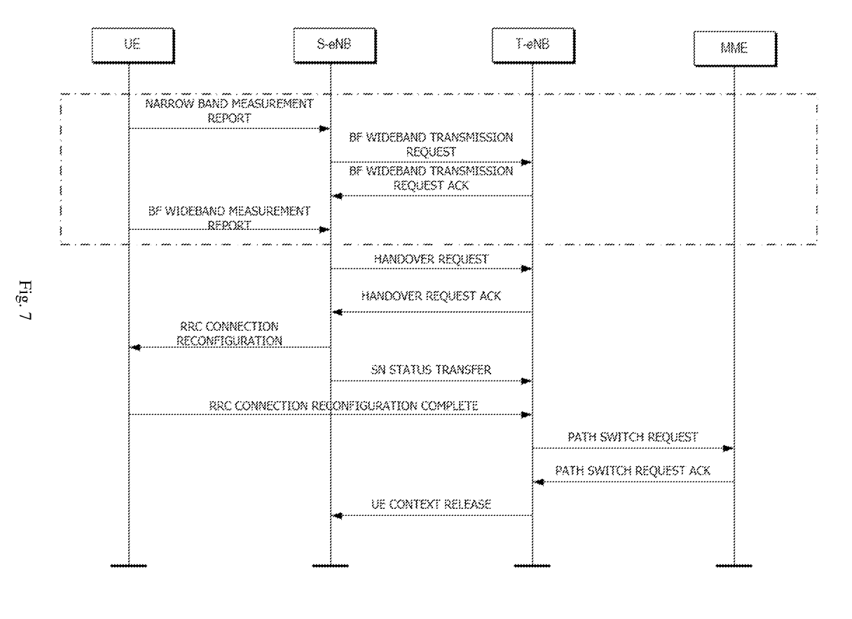

FIG. 6 illustrates a handover procedure within an eNB according to one embodiment of the present disclosure. In the embodiment shown in FIG. 6, a handover procedure within the eNB is provided. For example, the following steps are optionally included therein:

(1) UE sends a narrow band measurement report to S-eNB;

(2) S-eNB sends a beam-formed (BF) wideband measurement request to UE;

(3) UE sends a beam-formed (BF) wideband measurement report to S-eNB;

(4) S-eNB sends RRC connection reconfiguration to UE; and

(5) UE sends RRC connection reconfiguration complete to S-eNB.

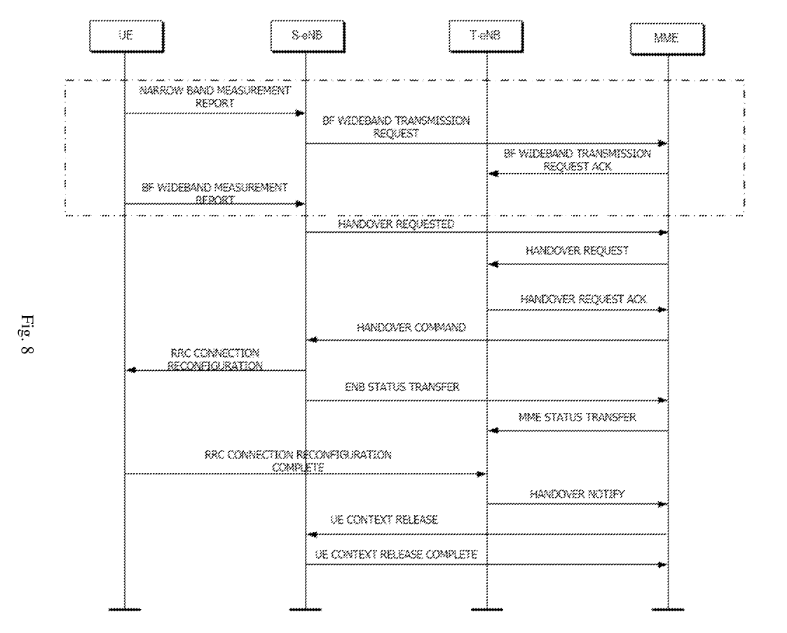

FIG. 7 illustrates a handover procedure between eNBs through an X2 interface according to another embodiment of the present disclosure. In the embodiment as shown in FIG. 7, handover between eNBs through an X2 interface is provided. For example, the following steps are optionally included therein:

(1) UE sends a narrow band measurement report to S-eNB;

(2) S-eNB sends a BF broad transmission request to T-eNB;

(3) T-eNB sends a BF broad transmission request ACK to S-eNB;

(4) UE sends a BF broad measurement report to S-eNB;

(5) S-eNB sends a handover request to T-eNB;

(6) T-eNB sends a handover request ACK to S-eNB;

(7) S-eNB sends RRC connection reconfiguration to UE;

(8) S-eNB sends SN status transfer to T-eNB;

(9) UE sends RRC connection reconfiguration complete to T-eNB;

(10) T-eNB sends a path switch request to MME;

(11) MME sends a path switch request ACK to T-eNB; and

(12) T-eNB sends UE context release to S-eNB.

FIG. 8 illustrates a handover procedure between eNBs through an S1 interface according to a further embodiment of the present disclosure. In the embodiment as shown in FIG. 8, a handover procedure between eNBs through an S1 interface is provided. For example, the following steps are optionally included therein:

(1) UE sends a narrow band measurement report to S-eNB;

(2) S-eNB sends a BF wideband transmission request to MME;

(3) MME sends a BF wideband transmission request ACK to T-eNB;

(4) UE sends a BF wideband measurement report to S-eNB;

(5) S-eNB sends a handover request to MME;

(6) MME sends a handover request to T-eNB;

(7) T-eNB sends a handover request ACK to MME;

(8) MME sends a handover command to S-eNB;

(9) S-eNB sends RRC connection reconfiguration to UE;

(10) S-eNB sends eNB status transfer to MME;

(11) MME sends MME status transfer to T-eNB;

(12) UE sends RRC connection reconfiguration complete to T-eNB;

(13) T-eNB sends a handover notification to MME;

(14) MME sends UE context release to S-eNB; and

(15) S-eNB sends UE context release complete to MME.

As shown in dashed blocks in FIGS. 6-8, the method of mobility management of the UE by the base station according to embodiments of the present disclosure may comprise the following steps: the base station transmits a narrow band signal on a part of a system bandwidth used by the base station; the base station, while the narrow band signal is transmitted, sets at least a part of an available bandwidth from the system bandwidth unused for signal transmission; the UE receives, from the base station, the narrow band signal transmitted on the part of the system bandwidth used by the base station, and provides a feedback on the narrow band signal; and the base station, based on the feedback from the UE, performs mobility management on the UE.

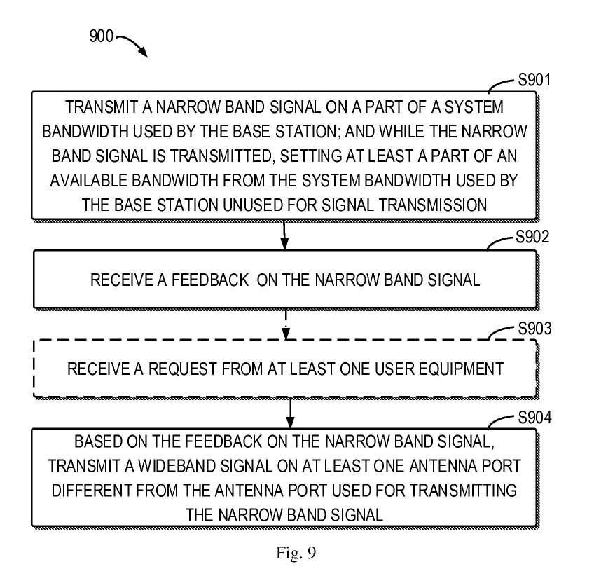

FIG. 9 illustrates a flowchart of a signal transmission method in a base station according to various embodiments of the present disclosure.

As shown in FIG. 9, at S901, a narrow band signal is transmitted on a part of a system bandwidth used by the base station; and during transmission of the narrow band signal, a part of an available bandwidth from the system bandwidth used by the base station is set unused for signal transmission.

In one embodiment of the present disclosure, transmitting a narrow band signal on a part of a system bandwidth used by the base station comprises transmitting a non-beam-formed narrow band signal on at least one antenna port.

In one embodiment of the present disclosure, the narrow band signal includes a reference signal. For example, as shown in FIG. 3, the bandwidth of the narrow band which is defined with X Resource Blocks (RB) locates in the center of the whole system bandwidth, and the dedicated RSs marked black are embedded within the narrow band.

In one embodiment of the present disclosure, transmitting a narrow band signal on a part of a system bandwidth used by the base station comprises, if the number of antenna ports is greater than 1, using “Transmit Diversity” mode as transmission mode (TM) to transmit the narrow band signal on the part of the system bandwidth used by the base station. For example, FIG. 4 illustrates an example of transmitting a narrow band RS according to embodiments of the present disclosure. In FIG. 4, an antenna port 1 (including four antenna elements marked black) is configured to transmit narrow band signals with dedicated RSs. The used transmission mode (TM) is “Transmit Diversity” to guarantee that all candidate users can receive those signals. It should be noted, TM used herein may be the same as used in 4G networks. The other remaining antenna ports may be configured to transmit data to the scheduled user with beam-formed transmission. For downlink data transmission, full bandwidth resources may be used for beam-based transmission. Because the pencil beam transmission points to the user being served, and this will not cause interferences to all the candidate users. Alternatively, full bandwidth except the dedicated narrow band can be used for beam-based transmission to fulfil other purposes. FIG. 1 illustrates downlink transmission and downlink interference impact.

In one embodiment, the reference signal is used to differentiate different base stations. For example, it may be used to differentiate base stations, for example in the two MMW cells, eNB#1 and eNB#2, as shown in FIG. 1.

In one embodiment of the present disclosure, it further comprises increasing transmission power of the narrow band signal. Considering that in a practical system, the transmission power per antenna element is limited. Hence, in one embodiment of the present disclosure, it is assumed that the whole bandwidth has M resource blocks, and the narrow band occupies N resource blocks. Comparing with the whole bandwidth RS transmission, which is the case in LTE-A, the power boosting gain per RB within the narrow band can be achieved as:

$${η}_{gain} = \frac{{P}_{NB}}{{P}_{FB}} = \frac{\frac{{P}_{0}}{N}}{\frac{{P}_{0}}{M}} = \frac{M}{N}$$

where P_{NB} represents the transmission power per RB used for narrow band RS transmission, and P_{FB} represents the transmission power per RB used for wide RS transmission. Obviously, narrow band transmission can bring huge gain (log 10 (M/N)), thereby compensating the propagation loss.

At S902, after transmitting the narrow band signal, the base station further receives a feedback on the narrow band signal.

At S904, after transmitting the narrow band signal, based on the feedback on the narrow band signal, a wideband signal is transmitted on at least one antenna port different from the antenna port used for transmitting the narrow band signal.

In one embodiment of the present disclosure, transmitting a wideband signal on at least one antenna port different from the antenna port used for transmitting the narrow band signal comprises transmitting a beam-formed wideband signal on at least one antenna port different from the antenna port used for transmitting the narrow band signal. For example, after transmitting the narrow band signal as shown in FIG. 3, based on the feedback on the narrow band signal, a beam-formed wideband signal is transmitted on at least one antenna port different from the antenna port used for transmitting the narrow band signal. According to various embodiments of the present disclosure, as shown in FIG. 1, the pencil beam-based data transmission concentrates the transmission power and significantly improves the channel quality, which in turn enhances the value of post signal to interference plus noise (SINR) at the receiver side. Furthermore, pencil beam-based data transmission will not impact the narrow band RS detection, guaranteeing the dedicated narrow band RS coverage with a power boosting gain.

In one embodiment of the present disclosure, the wideband signal includes a reference signal. FIG. 5 illustrates beam-formed wideband reference signals where analogue RS structure is used as in LTE-A system.

In one embodiment of the present disclosure, the reference signal is used to differentiate different base stations. For example, it is used to differentiate base stations, for example, in two MMW cells, eNB#1 and eNB#2, as shown in FIG. 1.

In one embodiment of the present disclosure, based on reports of N-RSRP or N-RSRQ of a serving cell and neighboring cells, the serving cell will cooperate with the potential neighboring cells, e.g. eNB #2 to initiate the wideband CSI configuration The wideband RSs are beam-formed before transmission.

As shown in FIG. 9, prior to S904, S903 may be included. At S903, a request from at least one UE is received.

In one embodiment of the present disclosure, based on the request received from the at least one UE, the wideband signal is transmitted.

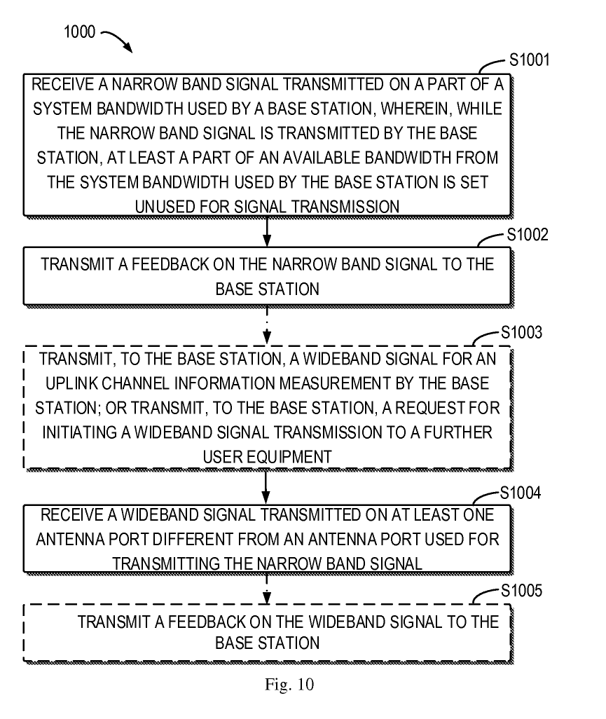

FIG. 10 illustrates a flowchart of a signal processing method in a UE according to various embodiments of the present disclosure.

As shown in FIG. 10, at S1001, a narrow band signal transmitted on one part of a system bandwidth used by the base station is received. While the narrow band signal is transmitted by the base station, at least a part of an available bandwidth from the system bandwidth used by the base station is set unused for signal transmission.

At S1002, a feedback for the narrow band signal is transmitted to the base station. For example, as shown in FIG. 1, a cell edge user (UE-1) can measure the dedicated narrow band channel state information of its serving cell (eNB #1) and its neighboring cell (eNB #2), respectively. The edge user measures a narrow band based RSRP (N-RSRP) or RSRQ (N-RSRQ) and sends the related reports to its serving cell (eNB #1). The uplink propagation loss may be compensated by the large antenna receiving gain at the eNB side.

At S1004, a beam-formed wideband signal, transmitted on at least one antenna port different from the antenna port used for transmitting the narrow band signal, is received.

At S1005, a feedback for the wideband signal is transmitted to the base station.

In one embodiment of the present disclosure, based on the wideband downlink channel quality measurements, an edge user reports the wideband RSRP (W-RSRP) or RSRQ (W-RSRQ) to its serving cell. The uplink propagation loss may also be compensated by the receiving gain of the large antenna array at the eNB side. According to the report of W-RSPR or W-RSRQ of a serving cell and neighboring cell(s), the serving cell implements the subsequent operations for user mobile management.

As stated above, alternatively, beam-forming the wideband RS may be based on the relevant report fed back in the first phase. However, the beam-forming wideband RS may be based on a wideband signal transmitted by the UE prior to the beam-forming. As shown in FIG. 10, prior to S1004, S1003 may be involved. At S1003, a wideband signal is transmitted to the base station for an uplink channel information measurement by the base station. Alternatively, at S1003, a wideband transmission request is transmitted to the base station for initiating a wideband signal transmission to other UE.

The detailed design of a beam vector used for the wideband RS transmission may be left for the future works. However, following conditions should be satisfied.

(1) The beam vectors for wideband RS transmission should be able to provide a gain as large as the power boosting gain in the first phase. This beam-forming gain is used to compensate the propagation loss.

(2) The size of beam vectors of a serving cell and that of the neighboring cells are the same. The purpose of this is to guarantee that the different cells can provide roughly same beam-forming gain for wideband RS transmission.

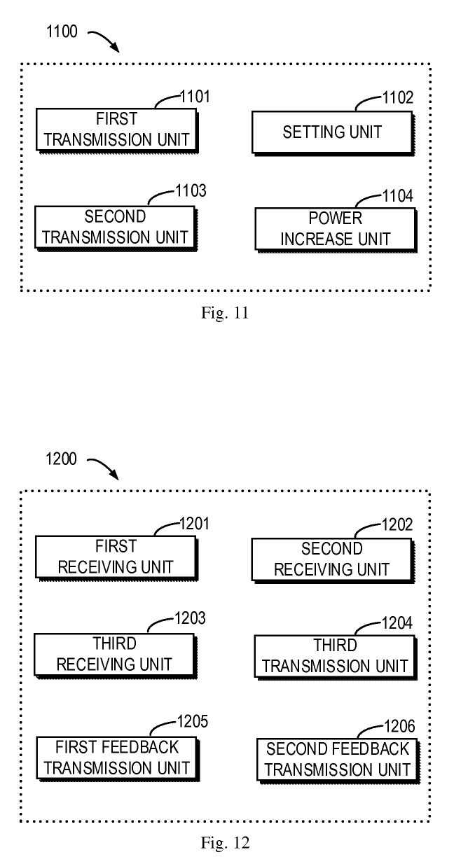

FIG. 11 illustrates a signal transmission device 1100 in a base station according to embodiments of the present disclosure. The signal transmission device 1100 comprises a first transmission unit 1101, a setting unit 1102, a second transmission unit 1103 and a power increase unit 1104. As stated below, each unit included therein is configured to perform respective operations of the base station according to embodiments of the present disclosure.

In one embodiment of the present disclosure, the first transmission unit 1101 is configured to transmit a narrow band signal on a part of a system bandwidth used by the base station. The setting unit 1102 is configured to, while the narrow band signal is transmitted, set at least a part of an available bandwidth from the system bandwidth used by the base station unused for signal transmission.

In one embodiment of the present disclosure, the first transmission unit 1101 is further configured to transmit non-beam-formed narrow band signal on at least one antenna port.

In one embodiment of the present disclosure, the power increase unit 1104 is configured to increase transmission power of the narrow band signal.

In one embodiment of the present disclosure, the first transmission unit 1101 is configured to, if the number of antenna ports is greater than 1, select a transmit diversity mode to transmit the narrow band signal on the part of the system bandwidth used by the base station.

In one embodiment of the present disclosure, the narrow band signal transmitted by the first transmission unit 1101 includes a reference signal.

In one embodiment of the present disclosure, the reference signal transmitted by the first transmission unit 1101 is configured to differentiate different base stations.

In one embodiment of the present disclosure, the narrow band signal transmitted by the first transmission unit 1101 is located in the center of a system bandwidth used by the base station.

In one embodiment of the present disclosure, the second transmission unit 1103 is configured to, after the transmission of the narrow band signal, transmit a wideband signal on at least one antenna port different from an antenna port used for the narrow band signal based on a feedback for the narrow band signal.

In one embodiment of the present disclosure, the second transmission unit 1103 is configured to transmit the wideband signal based on a request from at least one UE.

In one embodiment of the present disclosure, the second transmission unit 1103 is configured to transmit beam-formed wideband signal on at least one antenna port different from an antenna port used for the narrow band signal.

In one embodiment of the present disclosure, the wideband signal transmitted by the second transmission unit 1103 includes a reference signal.

In one embodiment of the present disclosure, the reference signal transmitted by the second transmission unit 1103 is configured to differentiate different base stations.

FIG. 12 illustrates a signal transmission device 1200 in a UE according to embodiments of the present disclosure. The signal transmission device 1200 comprises a first receiving unit 1201, a second receiving unit 1202, a third receiving unit 1203, a third transmission unit 1204, a first feedback transmission unit 1205 and a second feedback transmission 1206. As stated below, each unit included therein is configured to perform respective operations of the UE according to embodiments of the present disclosure.

In one embodiment of the present disclosure, the first receiving unit 1201 is configured to receive from a base station a narrow band signal transmitted on a part of a system bandwidth used by the base station. While the narrow band signal is transmitted by the base station, at least a part of an available bandwidth from the system bandwidth used by the base station is set unused for signal transmission.

In one embodiment of the present disclosure, the first feedback transmission unit 1205 is configured to transmit a feedback for the narrow band signal to the base station.

In one embodiment of the present disclosure, the second receiving unit 1202 is configured to receive a wideband signal transmitted on at least one antenna port different from an antenna port used for transmitting the narrow band signal.

In one embodiment of the present disclosure, the third receiving unit 1203 is configured to receive a beam-formed wideband signal transmitted on at least one antenna port different from an antenna port used for transmitting the narrow band signal.

In one embodiment of the present disclosure, the second feedback transmission unit 1206 is configured to transmit a feedback for the wideband signal to the base station.

In one embodiment of the present disclosure, the third transmission unit 1204 is configured to transmit a wideband signal to the base station for an uplink channel information measurement by the base station; or to transmit a request to the base station for initiating a wideband signal transmission to other UE.

As discussed above, various embodiments according to the present disclosure have been described, but it should be appreciated that these embodiments are not intended to limit embodiments of the present disclosure, and the scope of embodiments of the present disclosure is only defined by appended claims.

1. A method of signal transmission implemented in a base station, comprising:
transmitting a narrow band signal on a part of a system bandwidth used by the base station; and
while the narrow band signal is transmitted, setting at least a part of an available bandwidth from the system bandwidth used by the base station unused for signal transmission.

2. The method according to claim 1, wherein the transmitting a narrow band signal on a part of a system bandwidth used by the base station comprises:
transmitting the non-beam-formed narrow band signal on at least one antenna port.

3. The method according to claim 1, further comprising:
increasing a transmission power for the narrow band signal.

4. (canceled)

5. The method according to claim 1, wherein the narrow band signal includes a reference signal.

6. (canceled)

7. The method according to claim 1, wherein the narrow band signal is located in a center of the system bandwidth used by the base station.

8. The method according to claim 1, further comprising:
after the transmission of the narrow band signal, transmitting, based on a feedback on the narrow band signal, a wideband signal on at least one antenna port different from an antenna port used for transmitting the narrow band signal.

9. (canceled)

10. The method according to claim 8, wherein the transmitting a wideband signal on at least one antenna port different from an antenna port used for transmitting the narrow band signal comprises:
transmitting the beam-formed wideband signal on the at least one antenna port different from the antenna port used for transmitting the narrow band signal.

11. The method according to claim 8, wherein the wideband signal includes a reference signal.

12. (canceled)

13. A method of signal processing implemented in a UE, comprising:
receiving a narrow band signal transmitted on a part of a system bandwidth used by a base station, wherein, while the narrow band signal is transmitted by the base station, at least a part of an available bandwidth from the system bandwidth used by the base station is set unused for signal transmission.

14. The method according to claim 13, further comprising:
transmitting, to the base station, a feedback on the narrow band signal.

15. (canceled)

16. The method according to claim 14, further comprising:
receiving a beam-formed wideband signal on at least one antenna port different from the antenna port used for transmitting the narrow band signal.

17. The method according to claim 16, further comprising:
transmitting, to the base station, a feedback on the wideband signal.

18. The method according to claim 14, further comprising:
transmitting, to the base station, a wideband signal for an uplink channel information measurement by the base station; or
transmitting, to the base station, a request for initiating a wideband signal transmission to a further UE.

19. An apparatus of signal transmission in a base station, comprising:
a first transmission unit configured to transmit a narrow band signal on a part of a system bandwidth used by the base station; and
a setting unit configured to, while the narrow band signal is transmitted, set at least a part of an available bandwidth from the system bandwidth used by the base station unused for signal transmission.

20.-30. (canceled)

31. An apparatus of signal transmission in a UE, comprising:
a first receiving unit configured to receive, from a base station, a narrow band signal transmitted on a part of a system bandwidth used by the base station, wherein, while the narrow band signal is transmitted by the base station, at least a part of an available bandwidth from the system bandwidth used by the base station is set unused for signal transmission.

32.-36. (canceled)
